(19) United States
(12) Patent Application Publication
(10) Pub. No.: US 2025/0252535 A1
(43) Pub. Date: Aug. 7, 2025

(54) IMAGE DISPLAY APPARATUS

(71) Applicant: LG ELECTRONICS INC., Seoul (KR)

(72) Inventors: Wonjin LEE, Seoul (KR); Changsun LEEM, Seoul (KR); Kyeongryeol PARK, Seoul (KR); Saem PARK, Seoul (KR)

(73) Assignee: LG ELECTRONICS INC., Seoul (KR)

(21) Appl. No.: 19/043,020

(22) Filed: Jan. 31, 2025

(30) Foreign Application Priority Data
Feb. 1, 2024 (KR) 10-2024-0016106
Oct. 8, 2024 (KR) 10-2024-0136281

(51) Int. Cl. G06T 5/40; G06T 5/73; G06T 5/94; G06T 7/90

(52) U.S. Cl. CPC G06T 5/40; G06T 5/73; G06T 5/94; G06T 7/90; G06T 2207/10024

(57) ABSTRACT

An image display apparatus may include a display, and a signal processing device configured to process an input image signal and output an output image signal. The signal processing device may be configured to extract an image map and a color histogram of the input image signal, update the image map based on the color histogram, and perform image quality processing based on the updated image map.

### CROSS-REFERENCE TO RELATED APPLICATIONS

This application claims priority to and the benefit of Korean Application No. 10-2024-0016106, filed in the Korean Intellectual Property Office on Feb. 1, 2024, and Korean Application No. 10-2024-0136281, filed in the Korean Intellectual Property Office on Oct. 8, 2024, the entire contents of all these applications being incorporated herein by reference into the present application.

### BACKGROUND

### 1. Field

The present disclosure relates to an image display apparatus, and more particularly, to an image display apparatus capable of enhancing the sense of presence while reducing artifacts.

### 2. Description of the Related Art

An image display apparatus is an apparatus that displays images.

The image display apparatus is capable of displaying an image stored inside or an image received from outside.

In keeping with the trend toward large-sized displays for image display apparatuses, research is being conducted on methods for improving the picture quality of images.

A related art document, Korean Laid-Open Patent No. 10-2015-0007880, relates to a method, apparatus, and recording medium for improving image quality, which discloses identifying a first region corresponding to a predetermined color group and a second region excluding the first region from the input image and changing the values of pixels in at least one of the first and second regions.

However, according to the related art document, only a specific region, for instance, a region having a distribution of colors (e.g., skin tone) similar to that of a face region, is detected from an image, and this can increase the probability of erroneous detection if there are many other regions, apart from the specific region, that have a similar distribution of colors (e.g., skin tone).

### SUMMARY

An object of the present disclosure is to provide an image display apparatus capable of enhancing the sense of presence while reducing artifacts.

Another object of the present disclosure is to provide an image display apparatus capable of enhancing the sense of presence while reducing artifacts in response to motion of an object in an image.

An embodiment of the present disclosure provides an image display apparatus that may include a display; and a signal processing device configured to process an input image signal and output an output image signal, wherein the signal processing device is configured to extract an image map of the input image signal and color histogram of a plurality of regions of the input image signal, update the image map based on the color histogram of the plurality of regions, and perform image quality processing based on the updated image map.

The signal processing device may be configured to extract an image map of a first frame image of the input image signal, update the color histogram based on the image map of the first frame image and the color histogram of a frame image previous to the first frame image, update the image map of the first frame image based on the updated color histogram, and perform image quality processing based on the updated image map of the first frame image.

The signal processing device may be configured to extract an image map of the input image signal, extract color histogram of a plurality of regions of the input image signal, update the color histogram based on the image map and the ratio of foreground and background regions among the plurality of regions, update the image map based on the updated color histogram, and perform image equality processing based on the updated image map.

The signal processing device may be configured to extract an image map of the input image signal, extract color histogram of a plurality of regions of the input image signal, update the color histogram based on the image map and region of interest among the plurality of regions, update the image map based on the updated color histogram, and perform image quality processing based on the updated image map.

The signal processing device may be configured to extract an image map of the input image signal, perform color space-based conversion based on the image map, extract color histogram of a plurality of regions based on the color space-based conversion, update the image map based on the image map and the ratio of foreground and background regions among the plurality of regions, and perform image quality processing based on the updated image map.

While updating the image map, the signal processing device may be configured to increase the brightness of a first region among the plurality of regions in the updated image map as the level of color hue or saturation in the first region increases.

In response to motion of an object in consecutive first and second frame images, the signal processing device may be configured to extract an image map of the second frame image, update the color histogram image based on the image map of the second frame image and the color histogram, update the image map of the second frame image based on the updated color histogram, and perform image quality processing based on the updated image map of the second frame image.

The image map may include an artificial intelligence-based image map or a depth map.

The signal processing device may include: an image analyzer configured to extract an image map of an input image signal and color histogram of a plurality of regions of the input image signal; a map converter configured to update the image map based on the image map and the color histogram of the plurality of regions; and an image processor configured to perform image quality processing based on the updated image map.

The image analyzer may be configured to extract an image map or coordinate information based on the input image signal, or may be configured to extract an image map or coordinate information based on received metadata or a separate input image.

The image analyzer may be configured to process an image map on a pixel-by-pixel basis.

The map converter may be configured to separate and process image information for a chromatic region and image information for an achromatic region.

The map converter may be configured to update the image map based on a cumulative histogram of image information of a valid region.

The map converter may be configured to update the image map based on a cumulative histogram of image information of an invalid region and a cumulative histogram of image information of a valid region.

The map converter may be configured to update each region based on distribution of image information of the plurality of regions or update the image map based on each updated region.

The image processor may be configured to adjust the sharpness or contrast of a foreground region or a region of interest among the plurality of regions.

Another embodiment of the present disclosure provides an image display apparatus that may include a display; and a signal processing device configured to process an input image signal and output an output image signal, wherein, in response to motion of an object in consecutive first and second frame images, the signal processing device may be configured to extract an image map of the second frame image, update the color histogram image based on the image map of the second frame image and the color histogram, update the image map of the second frame image based on the updated color histogram, and perform image quality processing based on the updated image map of the second frame image.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing an image display apparatus according to an embodiment of the present disclosure;

FIG. 2 is an example of an internal block diagram of the image display apparatus;

FIG. 3 is an example of an internal block diagram of the signal processing device in FIG. 2.

FIG. 4A is a diagram showing a method of controlling a remote controller of FIG. 2;

FIG. 4B is an internal block diagram of the remote controller of FIG. 2;

FIGS. 5A and 5B are diagrams referred to in the description of an operation of an image display apparatus related to the present disclosure;

FIG. 6 is a flowchart showing an operation method for an image display apparatus according to an embodiment of the present disclosure;

FIG. 7A is a flowchart showing another operation method for an image display apparatus according to an embodiment of the present disclosure;

FIG. 7B is a flowchart showing still another operation method for an image display apparatus according to an embodiment of the present disclosure;

FIG. 8 is an internal block diagram of a signal processing device according to an embodiment of the present disclosure; and

FIGS. 9 to 11B are diagrams referred to in the description of FIGS. 6 to 8.

### DETAILED DESCRIPTION OF THE EMBODIMENTS

Hereinafter, the present disclosure will be described in detail with reference to the accompanying drawings.

Regarding constituent elements used in the following description, suffixes “module” and “unit” are given only in consideration of ease in the preparation of the specification, and do not have or serve as different meanings. Accordingly, the suffixes “module” and “unit” may be used interchangeably.

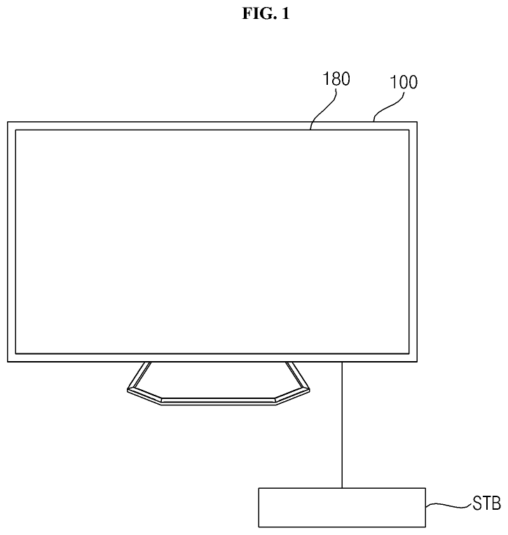

FIG. 1 is a diagram showing an image display apparatus according to an embodiment of the present disclosure.

Referring to the figure, an image display apparatus 100 may include a display 180.

The display 180 may be implemented by one of various panels. For example, the display 180 may be one of a liquid crystal panel (LCD panel), an organic light-emitting panel (OLED panel), an inorganic light-emitting panel (LED panel), etc.

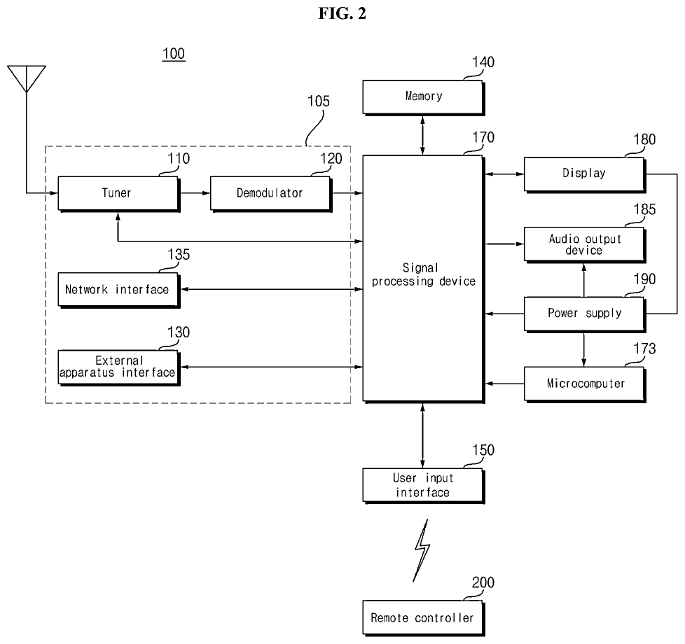

The image display apparatus 100 may receive a broadcast signal through an internal tuner (110 of FIG. 2).

Alternatively, the image display apparatus 100 may be connected to a set-top box STB, and may receive a broadcast signal or an image signal through the set-top box STB.

The image display apparatus 100 may externally receive an image signal over a wired or wireless network.

The image display apparatus 100 may receive an image signal from a connected external device.

In this case, the external device may be a set-top box STB, a mobile terminal, a USB-type storage device or tablet, or an HDMI-connected set-top box or laptop.

The image display apparatus 100 of FIG. 1 may be a TV, a monitor, a tablet PC, a mobile terminal, or the like.

FIG. 2 is an example of an internal block diagram of the image display apparatus of FIG. 1.

Referring to FIG. 2, the image display apparatus 100 according to an embodiment of the present disclosure may include an image receiver 105, an external apparatus interface 130, a memory 140, a user input interface 150, a sensor device, a signal processing device 170, a display 180, and an audio output device 185.

The image display apparatus 100 according to an embodiment of the present disclosure may further include a power supply 190 and a microcomputer 173.

The image receiver 105 may include a tuner 110, a demodulator 120, a network interface 135, and an external apparatus interface 130.

Meanwhile, unlike the figure, the image receiver 105 may include only the tuner 110, the demodulator 120, and the external apparatus interface 130. That is, the network interface 135 may not be included.

The tuner 110 selects an RF broadcast signal corresponding to a channel selected by a user or all pre-stored channels among radio frequency (RF) broadcast signals received through an antenna. In addition, the selected RF broadcast signal is converted into an intermediate frequency signal, a baseband image, or an audio signal.

For example, if the selected RF broadcast signal is a digital broadcast signal, the tuner 110 converts the digital broadcast signal into a digital IF (DIF) signal and, if the selected RF broadcast signal is an analog broadcast signal, the tuner 110 converts the analog broadcast signal into an analog baseband image or voice (CVBS/SIF) signal. That is, the tuner 110 may be configured to process a digital broadcast signal or an analog broadcast signal. The analog baseband image or voice (CVBS/SIF) signal output from the tuner 110 may be directly input to the signal processing device 170.

The tuner 110 may include a plurality of tuners for receiving broadcast signals of a plurality of channels. Alternatively, a single tuner that simultaneously receives broadcast signals of a plurality of channels is also available.

The demodulator 120 receives the converted digital IF signal DIF from the tuner 110 and performs a demodulation operation.

The demodulator 120 may be configured to perform demodulation and channel decoding and then output a stream signal TS. At this time, the stream signal may be a multiplexed signal of an image signal, an audio signal, or a data signal.

The stream signal output from the demodulator 120 may be input to the signal processing device 170. The signal processing device 170 performs demultiplexing, image/audio signal processing, and the like, and then outputs an image to the display 180 and outputs audio to the audio output device 185.

The external apparatus interface 130 may transmit or receive data with a connected external apparatus, e.g., a set-top box 50. To this end, the external apparatus interface 130 may include an A/V input and output device.

The external apparatus interface 130 may be connected in wired or wirelessly to an external apparatus, such as a digital versatile disk (DVD), a Blu ray, a game equipment, a camera, a camcorder, a computer (note book), and a set-top box, and may be configured to perform an input/output operation with an external apparatus.

The A/V input and output device may receive image and audio signals from an external apparatus. Meanwhile, a wireless transceiver may be configured to perform short-range wireless communication with other electronic apparatus.

Through the wireless transceiver, the external apparatus interface 130 may exchange data with an adjacent mobile terminal 600. In particular, in a mirroring mode, the external apparatus interface 130 may receive device information, executed application information, application image, and the like from the mobile terminal 600.

The network interface 135 provides an interface for connecting the image display apparatus 100 to a wired/wireless network including the Internet network. For example, the network interface 135 may receive, via the network, content or data provided by the Internet, a content provider, or a network operator.

The network interface 135 may include a wireless transceiver.

The memory 140 may store a program for each signal processing and control in the signal processing device 170, and may store signal-processed image, audio, or data signal.

In addition, the memory 140 may serve to temporarily store image, audio, or data signal input to the external apparatus interface 130. In addition, the memory 140 may store information on a certain broadcast channel through a channel memory function, such as a channel map.

Although FIG. 2 illustrates that the memory is provided separately from the signal processing device 170, the scope of the present disclosure is not limited thereto. The memory 140 may be included in the signal processing device 170.

The user input interface 150 transmits a signal input by the user to the signal processing device 170 or transmits a signal from the signal processing device 170 to the user.

For example, it may transmit/receive a user input signal, such as power on/off, channel selection, screen setting, etc., from a remote controller 200, may transfer a user input signal input from a local key, such as a power key, a channel key, a volume key, a set value, etc., to the signal processing device 170, may transfer a user input signal input from a sensor device that senses a user's gesture to the signal processing device 170, or may transmit a signal from the signal processing device 170 to the sensor device.

The signal processing device 170 may demultiplex the input stream through the tuner 110, the demodulator 120, the network interface 135, or the external apparatus interface 130, or process the demultiplexed signals to generate and output a signal for image or audio output.

For example, the signal processing device 170 receives a broadcast signal received by the image receiver 105 or an HDMI signal, and perform signal processing based on the received broadcast signal or the HDMI signal to thereby output a processed image signal.

The image signal processed by the signal processing device 170 is input to the display 180, and may be displayed as an image corresponding to the image signal. In addition, the image signal processed by the signal processing device 170 may be input to the external output apparatus through the external apparatus interface 130.

The audio signal processed by the signal processing device 170 may be output to the audio output device 185 as an audio signal. In addition, audio signal processed by the signal processing device 170 may be input to the external output apparatus through the external apparatus interface 130.

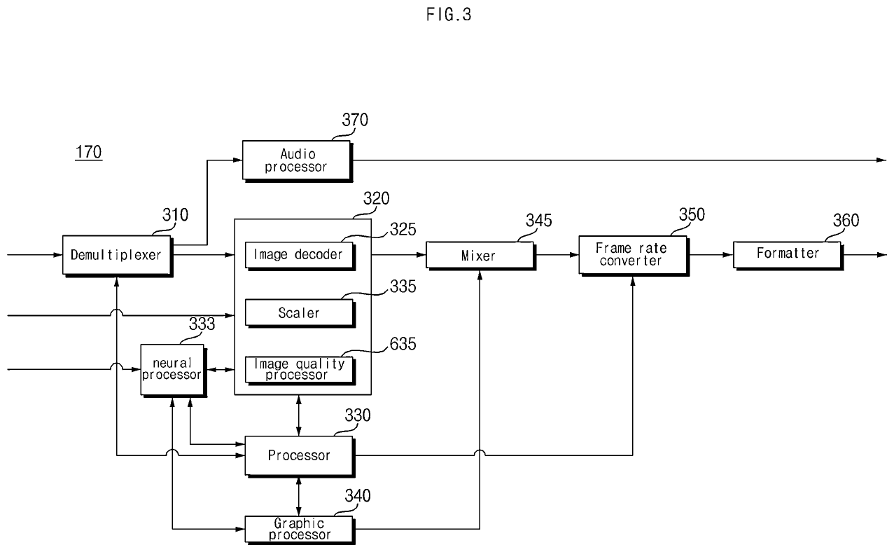

The signal processing device 170 may include a demultiplexer, an image processor, and the like. That is, the signal processing device 170 may be configured to perform a variety of signal processing and thus it may be implemented in the form of a system on chip (SOC). This will be described later with reference to FIG. 3.

In addition, the signal processing device 170 may be configured to control the overall operation of the image display apparatus 100. For example, the signal processing device 170 may be configured to control the tuner 110 to control the tuning of the RF broadcast corresponding to the channel selected by the user or the previously stored channel.

In addition, the signal processing device 170 may be configured to control the image display apparatus 100 according to a user command input through the user input interface 150 or an internal program.

The signal processing device 170 may be configured to control the display 180 to display an image. At this time, the image displayed on the display 180 may be a still image or a moving image, and may be a 2D image or a 3D image.

The signal processing device 170 may display a certain object in an image displayed on the display 180. For example, the object may be at least one of a connected web screen (newspaper, magazine, etc.), an electronic program guide (EPG), various menus, a widget, an icon, a still image, a moving image, and a text.

The signal processing device 170 may recognize the position of the user based on the image photographed by a photographing device. For example, the distance (z-axis coordinate) between a user and the image display apparatus 100 may be determined. In addition, the x-axis coordinate and the y-axis coordinate in the display 180 corresponding to a user position may be determined.

The display 180 generates a driving signal by converting an image signal, a data signal, an OSD signal, a control signal processed by the signal processing device 170, an image signal, a data signal, a control signal, and the like received from the external apparatus interface 130.

The display 180 may be configured as a touch screen and used as an input device in addition to an output device.

The audio output device 185 receives a signal processed by the signal processing device 170 and outputs it as an audio.

The photographing device photographs a user. The photographing device may be implemented by a single camera, but the present disclosure is not limited thereto and may be implemented by a plurality of cameras. Image information photographed by the photographing device may be input to the signal processing device 170.

The signal processing device 170 may sense a gesture of the user based on each of the images photographed by the photographing device, the signals detected from the sensor device, or a combination thereof.

The power supply 190 supplies corresponding power to the image display apparatus 100. Particularly, the power may be supplied to a signal processing device 170 which may be implemented in the form of a system on chip (SOC), a display 180 for displaying an image, and an audio output device 185 for outputting an audio.

Specifically, the power supply 190 may include an ac/dc converter for converting an alternating current voltage to a direct current voltage and a dc/dc converter for converting the level of direct current voltage.

The remote controller 200 transmits the user input to the user input interface 150. To this end, the remote controller 200 may use Bluetooth, a radio frequency (RF) communication, an infrared (IR) communication, an Ultra Wideband (UWB), ZigBee, or the like. In addition, the remote controller 200 may receive the image, audio, or data signal output from the user input interface 150, and display it on the remote controller 200 or output it as an audio.

The image display apparatus 100 may be a fixed or mobile digital broadcast receiver capable of receiving digital broadcast.

Meanwhile, a block diagram of the image display apparatus 100 shown in FIG. 2 is a block diagram for an embodiment of the present disclosure. Each component of the block diagram may be integrated, added, or omitted according to a specification of the image display apparatus 100 actually implemented. That is, two or more components may be combined into a single component as needed, or a single component may be split into two or more components. The function performed in each block is described for the purpose of illustrating embodiments of the present disclosure, and specific operation and apparatus do not limit the scope of the present disclosure.

FIG. 3 is an example of an internal block diagram of the signal processing device in FIG. 2.

Referring to the figure, the signal processing device 170 according to an embodiment of the present disclosure may include a demultiplexer 310, an image processor 320, a processor 330, and an audio processor 370. In addition, the signal processing device 170 may further include and a data processor.

The demultiplexer 310 demultiplexes the input stream. For example, when an MPEG-2 TS is input, it may be demultiplexed into image, audio, and data signal, respectively. Here, the stream signal input to the demultiplexer 310 may be a stream signal output from the tuner 110, the demodulator 120, or the external apparatus interface 130.

The image processor 320 may be configured to perform signal processing on an input image. For example, the image processor 320 may be configured to perform video processing on an image signal demultiplexed by the demultiplexer 310.

To this end, the image processor 320 may include an image decoder 325, a scaler 335, an image quality processor 635, an image encoder, a Graphic processor 340, a frame rate converter 350, a formatter 360, etc.

The image decoder 325 decodes a demultiplexed image signal, and the scaler 335 performs scaling so that the resolution of the decoded image signal may be output from the display 180.

The image decoder 325 may include a decoder of various standards. For example, an MPEG-2 decoder, an H.264 decoder, a 3D image decoder for a color image and a depth image, and a decoder for a multiple view image may be provided.

The scaler 335 may scale an input image signal decoded by the image decoder 325 or the like.

For example, if the size or resolution of an input image signal is small, the scaler 335 may upscale the input image signal, and, if the size or resolution of the input image signal is great, the scaler 335 may downscale the input image signal.

The image quality processor 635 may be configured to perform image quality processing on an input image signal decoded by the image decoder 325 or the like.

For example, the image quality processor 635 may be configured to perform noise reduction processing on an input image signal, extend the grayscale resolution of the input image signal, perform image resolution enhancement, perform high dynamic range (HDR)-based signal processing, vary frame rates, and perform image quality processing suitable for the properties of a panel.

The graphic processor 340 generates an OSD signal according to a user input or by itself. For example, based on a user input signal, the Graphic processor 340 may be configured to generate a signal for displaying various information as a graphic or a text on the screen of the display 180. The generated OSD signal may include various data, such as a user interface screen of the image display apparatus 100, various menu screens, a widget, and an icon. In addition, the generated OSD signal may include a 2D object or a 3D object.

In addition, the Graphic processor 340 may be configured to generate a pointer that may be displayed on the display, based on a pointing signal input from the remote controller 200. In particular, such a pointer may be generated by a pointing signal processing device, and the Graphic processor 340 may include such a pointing signal processing device. Obviously, the pointing signal processing device may be provided separately from the Graphic processor 340.

The frame rate converter (FRC) 350 may convert a frame rate of an input image. The frame rate converter 350 may output the input image without converting the frame rate. The formatter 360 may change a format of an input image signal into a format suitable for displaying the image signal on a display and output the image signal in the changed format.

In particular, the formatter 360 may change a format of an image signal to correspond to a display panel.

Further, the formatter 360 may convert the format of an image signal.

The processor 330 may be configured to control overall operations of the image display apparatus 100 or the signal processing device 170.

For example, the processor 330 may be configured to control the tuner 110 to control the tuning of an RF broadcast corresponding to a channel selected by a user or a previously stored channel.

In addition, the processor 330 may be configured to control the image display apparatus 100 according to a user command input through the user input interface 150 or an internal program.

In addition, the processor 330 may transmit data to the network interface 135 or to the external apparatus interface 130.

In addition, the processor 330 may be configured to control the demultiplexer 310, the image processor 320, and the like in the signal processing device 170.

The audio processor 370 in the signal processing device 170 may be configured to perform the audio processing of the demultiplexed audio signal. To this end, the audio processor 370 may include various decoders.

In addition, the audio processor 370 in the signal processing device 170 may be configured to process a base, a treble, a volume control, and the like.

The data processor in the signal processing device 170 may be configured to perform data processing of the demultiplexed data signal. For example, when the demultiplexed data signal is a coded data signal, it may be decoded. The encoded data signal may be electronic program guide information including broadcast information, such as a start time and an end time of a broadcast program broadcasted on each channel.

Meanwhile, a block diagram of the signal processing device 170 shown in FIG. 3 is a block diagram for an embodiment of the present disclosure. Each component of the block diagram may be integrated, added, or omitted according to a specification of the signal processing device 170 actually implemented.

In particular, the frame rate converter 350 and the formatter 360 may be provided separately in addition to the image processor 320.

The signal processing device 170 according to an embodiment of the present disclosure may further include a neural processor 333 for a learning process or the like.

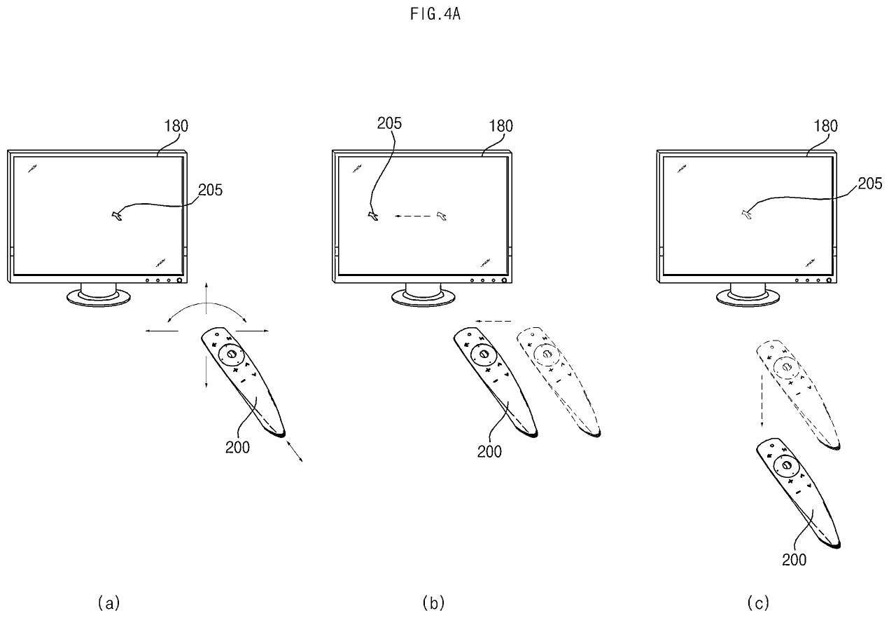

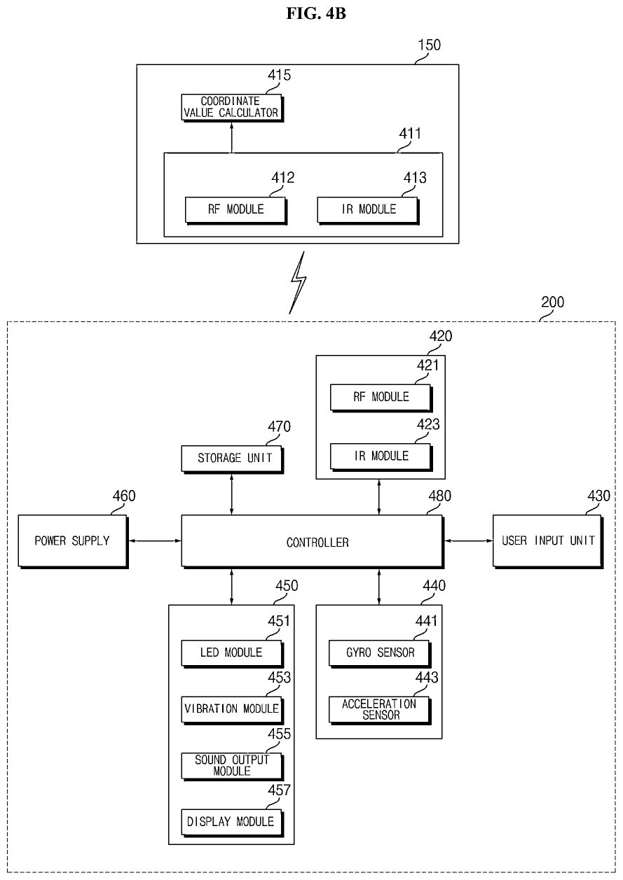

FIG. 4A is a diagram illustrating a control method of a remote controller of FIG. 2.

As shown in FIG. 4A(a), it is illustrated that a pointer 205 corresponding to the remote controller 200 is displayed on the display 180.

The user may move or rotate the remote controller 200 up and down, left and right (FIG. 4A(b)), and back and forth (FIG. 4A(c)). The pointer 205 displayed on the display 180 of the image display apparatus corresponds to the motion of the remote controller 200. Such a remote controller 200 may be referred to as a space remote controller or a 3D pointing apparatus, because the pointer 205 is moved and displayed according to the movement in a 3D space, as shown in the figure.

FIG. 4A(b) illustrates that when the user moves the remote controller 200 to the left, the pointer 205 displayed on the display 180 of the image display apparatus also moves to the left correspondingly.

Information on the motion of the remote controller 200 detected through a sensor of the remote controller 200 is transmitted to the image display apparatus. The image display apparatus may calculate the coordinate of the pointer 205 from the information on the motion of the remote controller 200. The image display apparatus may display the pointer 205 to correspond to the calculated coordinate.

FIG. 4A(c) illustrates a case where the user moves the remote controller 200 away from the display 180, while pressing a specific button of the remote controller 200. Thus, a selection area within the display 180 corresponding to the pointer 205 may be zoomed in so that it may be displayed to be enlarged. Meanwhile, when the user moves the remote controller 200 close to the display 180, the selection area within the display 180 corresponding to the pointer 205 may be zoomed out so that it may be displayed to be reduced. Meanwhile, when the remote controller 200 moves away from the display 180, the selection area may be zoomed out, and when the remote controller 200 approaches the display 180, the selection area may be zoomed in.

Meanwhile, when the specific button of the remote controller 200 is pressed, it is possible to exclude the recognition of vertical and lateral movement. That is, when the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state where the specific button of the remote controller 200 is not pressed.

The moving speed or the moving direction of the pointer 205 may correspond to the moving speed or the moving direction of the remote controller 200.

FIG. 4B is an internal block diagram of the remote controller of FIG. 2.

Referring to the figure, the remote controller 200 includes a wireless transceiver 425, a user input device 430, a sensor device 440, an output device 450, a power supply 460, a memory 470, and a controller 480.

The wireless transceiver 425 transmits/receives a signal to/from any one of the image display apparatuses according to the embodiments of the present disclosure described above. Among the image display apparatuses according to the embodiments of the present disclosure, one image display apparatus 100 will be described as an example.

In the present embodiment, the remote controller 200 may include an RF module 421 for transmitting and receiving signals to and from the image display apparatus 100 according to a RF communication standard. In addition, the remote controller 200 may include an IR module 423 for transmitting and receiving signals to and from the image display apparatus 100 according to a IR communication standard.

In the present embodiment, the remote controller 200 transmits a signal containing information on the motion of the remote controller 200 to the image display apparatus 100 through the RF module 421.

In addition, the remote controller 200 may receive the signal transmitted by the image display apparatus 100 through the RF module 421. In addition, if necessary, the remote controller 200 may transmit a command related to power on/off, channel change, volume change, and the like to the image display apparatus 100 through the IR module 423.

The user input device 430 may be implemented by a keypad, a button, a touch pad, a touch screen, or the like. The user may operate the user input device 430 to input a command related to the image display apparatus 100 to the remote controller 200. When the user input device 430 includes a hard key button, the user may input a command related to the image display apparatus 100 to the remote controller 200 through a push operation of the hard key button. When the user input device 430 includes a touch screen, the user may touch a soft key of the touch screen to input the command related to the image display apparatus 100 to the remote controller 200. In addition, the user input device 430 may include various types of input means, such as a scroll key, a jog key, etc., which may be operated by the user, and the present disclosure does not limit the scope of the present disclosure.

The sensor device 440 may include a gyro sensor 441 or an acceleration sensor 443. The gyro sensor 441 may sense information regarding the motion of the remote controller 200.

For example, the gyro sensor 441 may sense information on the operation of the remote controller 200 based on the x, y, and z axes. The acceleration sensor 443 may sense information on the moving speed of the remote controller 200. Meanwhile, a distance measuring sensor may be further provided, and thus, the distance to the display 180 may be sensed.

The output device 450 may output an image or an audio signal corresponding to the operation of the user input device 430 or a signal transmitted from the image display apparatus 100. Through the output device 450, the user may recognize whether the user input device 430 is operated or whether the image display apparatus 100 is controlled.

For example, the output device 450 may include an LED module 451 that is turned on when the user input device 430 is operated or a signal is transmitted/received to/from the image display apparatus 100 through the wireless transceiver 425, a vibration module 453 for generating a vibration, an audio output module 455 for outputting an audio, or a display module 457 for outputting an image.

The power supply 460 supplies power to the remote controller 200. When the remote controller 200 is not moved for a certain time, the power supply 460 may stop the supply of power to reduce a power waste. The power supply 460 may resume power supply when a certain key provided in the remote controller 200 is operated.

The memory 470 may store various types of programs, application data, and the like necessary for the control or operation of the remote controller 200. If the remote controller 200 wirelessly transmits and receives a signal to/from the image display apparatus 100 through the RF module 421, the remote controller 200 and the image display apparatus 100 transmit and receive a signal through a certain frequency band. The controller 480 of the remote controller 200 may store information regarding a frequency band or the like for wirelessly transmitting and receiving a signal to/from the image display apparatus 100 paired with the remote controller 200 in the memory 470 and may refer to the stored information.

The controller 480 controls various matters related to the control of the remote controller 200. The controller 480 may transmit a signal corresponding to a certain key operation of the user input device 430 or a signal corresponding to the motion of the remote controller 200 sensed by the sensor device 440 to the image display apparatus 100 through the wireless transceiver 425.

The user input interface 150 of the image display apparatus 100 includes a wireless transceiver 151 that may wirelessly transmit and receive a signal to and from the remote controller 200 and a coordinate value calculator 415 that may calculate the coordinate value of a pointer corresponding to the operation of the remote controller 200.

The user input interface 150 may wirelessly transmit and receive a signal to and from the remote controller 200 through the RF module 412. In addition, the user input interface 150 may receive a signal transmitted by the remote controller 200 through the IR module 413 according to a IR communication standard.

The coordinate value calculator 415 may correct a hand shake or an error from a signal corresponding to the operation of the remote controller 200 received through the wireless transceiver 151 and calculate the coordinate value (x, y) of the pointer 205 to be displayed on the display 180.

The transmission signal of the remote controller 200 inputted to the image display apparatus 100 through the user input interface 150 is transmitted to the controller 180 of the image display apparatus 100. The controller 180 may determine the information on the operation of the remote controller 200 and the key operation from the signal transmitted from the remote controller 200, and, correspondingly, control the image display apparatus 100.

For another example, the remote controller 200 may calculate the pointer coordinate value corresponding to the operation and output it to the user input interface 150 of the image display apparatus 100. In this case, the user input interface 150 of the image display apparatus 100 may transmit information on the received pointer coordinate value to the controller 180 without a separate correction process of hand shake or error.

For another example, unlike the figure, the coordinate value calculator 415 may be provided in the signal processing device 170, not in the user input interface 150.

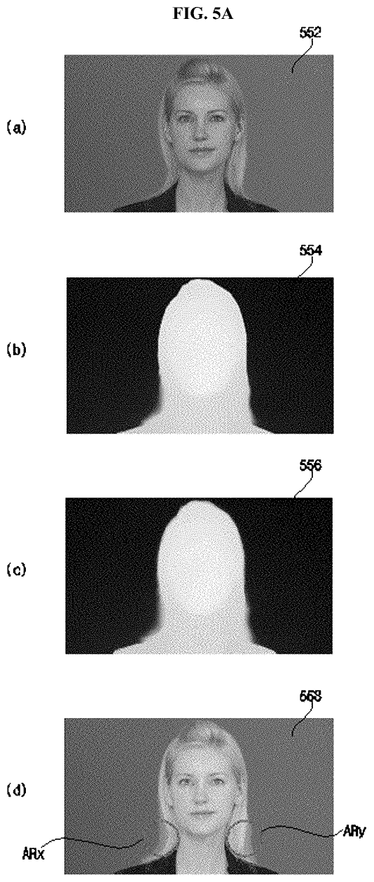

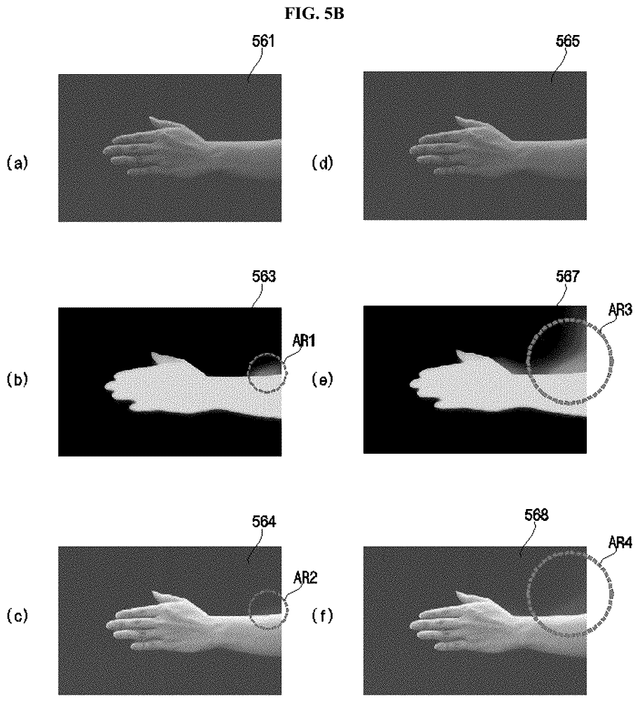

FIGS. 5A and 5B are diagrams referred to in the description of an operation of an image display apparatus related to the present disclosure.

FIG. 5A illustrates how signal processing of an input image works in an image display apparatus related to the present disclosure.

Referring to the drawing, an image display apparatus 100 related to the present disclosure extracts a depth map of an input image 552 shown in (a) of FIG. 5A.

Meanwhile, a depth map 554 corresponding to the input image 552 may be as illustrated in (b) of FIG. 5A.

On the other hand, the image display apparatus 100 related to the present disclosure may be configured to extract a depth map 556 as shown in (c) of FIG. 5A, not the depth map 554 shown in (b) of FIG. 5A.

From a comparison between the depth map 554 in (b) of FIG. 5A and the depth map 556 in (c) of FIG. 5A, it can be seen that there is even more blurring of boundary regions around the person's shoulder or hair in the depth map 556 in (c) of FIG. 5A.

Meanwhile, in a case where the image display apparatus 100 related to the present disclosure performs image quality processing based on the depth map 556 in (a) of FIG. 5A, it may display an image 558 as shown in (d) of FIG. 5A.

As can be seen from the image 558 in (d) of FIG. 5A, artifacts appear in the boundary regions ARx and ARy around the person's shoulder or hair.

FIG. 5B illustrates how signal processing of first and second consecutive frame images works in an image display apparatus related to the present disclosure.

Referring to the drawing, the image display apparatus 100 related to the present disclosure extracts a depth map of a first frame image 561 shown in (a) of FIG. 5B.

That is, the image display apparatus 100 related to the present disclosure extracts a depth map 563 as shown in (b) of FIG. 5B.

The depth map 563 in (b) of FIG. 5B illustrates that there is partial blurring of the boundary region AR1 around the wrist.

Meanwhile, in a case where the image display apparatus 100 related to the present disclosure performs image quality processing based on the depth map 563 in (b) of FIG. 5B, it may display an image 564 as shown in (c) of FIG. 5B.

As can be seen from the image 564 in (c) of FIG. 5B, artifacts appear in the boundary region AR2 around the wrist.

Next, the image display apparatus 100 related to the present disclosure extracts a depth map of a second frame image 565 shown in (d) of FIG. 5B.

In this case, the second frame image 565 is an image subsequent to the first frame image 561, and there may be motion of the wrist which is at least part of an object in the image.

That is, the image display apparatus 100 related to the present disclosure extracts a depth map 567 as shown in (e) of FIG. 5B, corresponding to the second frame image 565.

The depth map 567 in (e) of FIG. 5B illustrates that there is partial blurring of the boundary region AR3 around the wrist.

Particularly, as compared to the depth map 563 in (b) of FIG. 5B, it can be observed that there is even more blurring of the boundary region AR3 around the wrist in the depth map 567 in (e) of FIG. 5B.

Meanwhile, in a case where the image display apparatus 100 related to the present disclosure image quality processing based on the depth map 567 in (e) of FIG. 5B, it may display an image 568 as shown in (f) of FIG. 5B.

As can be seen from the image 568 in (f) of FIG. 5B, artifacts appear in the boundary region AR4 around the wrist. More severe artifacts are produced, especially, when there is motion of an object, such as the wrist.

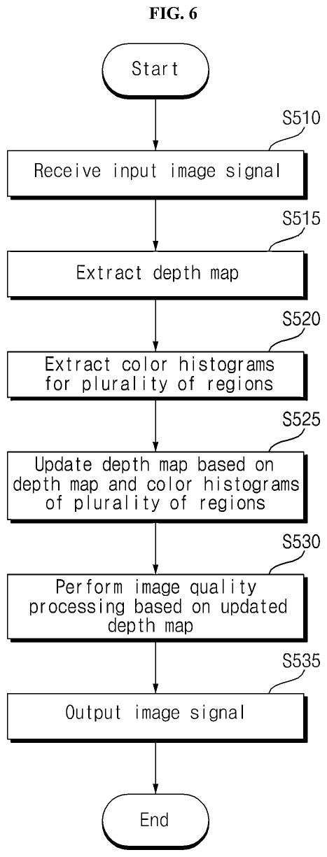

In this regard, the present disclosure proposes a method in which, in image processing, artifacts can be reduced and the sense of presence can be enhanced. Furthermore, the present disclosure provides a method in which, in response to motion of an object in an image, artifacts can be reduced and the sense of presence can be enhanced. This will be discussed with reference to FIG. 6 and the subsequent figures.

FIG. 6 is a flowchart showing an operation method for an image display apparatus according to an embodiment of the present disclosure.

Referring to the drawing, the signal processing device 170 in the image display apparatus 100 according to an embodiment of the present disclosure receives an input image signal (S510).

In this case, the input image signal may be an input image signal from an external set-top box STB, a broadcast image signal received from the tuner 110, an image signal stored in the memory 140, an image signal inputted via the external apparatus interface 130, or an image signal inputted via the network interface 135.

Next, the signal processing device 170 extracts an image map or a depth map of the input image signal (S515).

The image map may include an artificial intelligence-based image map or depth map.

That is, the signal processing device 170 according to an embodiment of the present disclosure may be configured to extract an artificial intelligence-based image map.

As another example, the signal processing device 170 according to an embodiment of the present disclosure may be configured to extract a depth map.

The signal processing device 170 according to an embodiment of the present disclosure extracts color histogram of a plurality of regions of the input image signal (S520).

The step S520 may be performed in parallel or simultaneously with the step S515, not after the step S515.

For example, the signal processing device 170 according to an embodiment of the present disclosure may be configured to extract HSV data of the input image signal, which is hue, saturation, and value data, and extract a histogram of hue, saturation, and value data for each of the plurality of regions.

The signal processing device 170 according to an embodiment of the present disclosure may divide the plurality of regions into a foreground region and a background region.

The signal processing device 170 according to an embodiment of the present disclosure may divide the plurality of regions into a region of interest and a region of no interest or into a valid region and an invalid region.

Next, the signal processing device 170 according to an embodiment of the present disclosure updates the image map or the depth map based on the color histogram of the plurality of regions (S525).

For example, the signal processing device 170 according to an embodiment of the present disclosure may be configured to update the image map based on the depth map and the color histogram of the plurality of regions.

Meanwhile, while updating the image map, the signal processing device 170 may be configured to increase the brightness of a first region among the plurality of regions in the updated image map as the level of color hue or saturation in the first region increases.

Meanwhile, while updating the image map, the signal processing device 170 may be configured to decrease the brightness of a first region among the plurality of regions in the updated image map as the level of color hue or saturation in the first region decreases.

Next, the signal processing device 170 according to an embodiment of the present disclosure performs image quality processing based on the updated image map or the updated depth map (S530).

For example, the signal processing device 170 may be configured to adjust the sharpness and contrast of a foreground region among the plurality of regions on a pixel-by-pixel basis based on the updated image map, so as to make the foreground region stand out. Accordingly, it is possible to enhance the sense of presence in the foreground region while reducing artifacts.

As another example, the signal processing device 170 may be configured to adjust the sharpness and contrast of a region of interest among the plurality of regions on a pixel-by-pixel basis based on the updated image map, so as to make the region of interest stand out. Accordingly, it is possible to enhance the sense of presence in the region of interest while reducing artifacts.

Next, the signal processing device 170 according to an embodiment of the present disclosure outputs an output image signal produced by image quality processing to the display 180 (S535).

Accordingly, the display 180 is able to display an image with less artifacts and an enhanced sensed of presence.

According to FIG. 6, the signal processing device 170 according to an embodiment of the present disclosure extracts an image map of an input image signal and color histogram of a plurality of regions of the input image signal, update the image map based on the color histogram of the plurality of regions, and perform image quality processing based on the updated image map. Accordingly, it is possible to enhance the sense of presence while reducing artifacts.

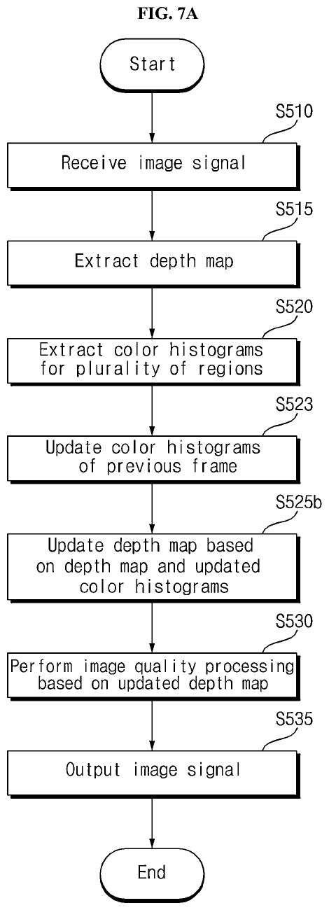

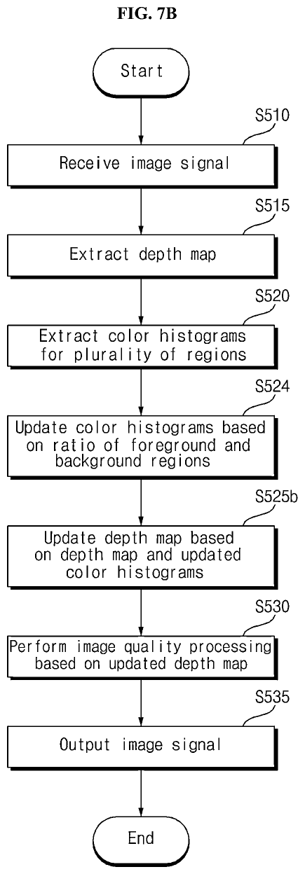

FIG. 7A is a flowchart showing another operation method for an image display apparatus according to an embodiment of the present disclosure.

Referring to the drawing, although the operation method for an image display apparatus according to an embodiment of the present disclosure illustrated in FIG. 7A is similar to that of FIG. 6, there are differences in the step S523 and the step S525b. The following description will be given focusing on the differences.

After extracting color histogram of a plurality of regions of an input image signal in the step S520, the signal processing device 170 may be configured to perform the step S523 and the step S525b.

That is, the signal processing device 170 may be configured to update the color histogram of a previous frame image based on the image map of the input image signal (S523). For example, the signal processing device 170 may be configured to update the color histogram of the plurality of regions in the previous frame image based on the image map of the input image signal.

Next, the signal processing device 170 may be configured to update the image map or the depth map based on the updated color histogram of the plurality of regions (S525b).

For example, the signal processing device 170 may be configured to update the image map based on the depth map and the updated color histogram of the plurality of regions.

Next, the signal processing device 170 performs image quality processing based on the updated image map or the updated depth map (S530). Accordingly, it is possible to enhance the sense of presence while reducing artifacts.

According to FIG. 7A, the signal processing device 170 may be configured to extract an image map of a first frame image of an input image signal, update the color histogram based on the image map of the first frame map and the color histogram of a frame image previous to the first frame image, update the image map of the first frame image based on the updated color histogram, and perform image quality processing based on the updated image map of the first frame image. Accordingly, it is possible to enhance the sense of presence while reducing artifacts.

Meanwhile, in response to motion of an object in consecutive first and second frame images, the signal processing device 170 according to another embodiment of the present disclosure extracts an image map of the second frame image, update the color histogram image based on the image map of the second frame image and the color histogram, update the image map of the second frame image based on the updated color histogram, and perform image quality processing based on the updated image map of the second frame image. Accordingly, it is possible to enhance the sense of presence while reducing artifacts in response to motion of an object in the image.

FIG. 7B is a flowchart showing still another operation method for an image display apparatus according to an embodiment of the present disclosure.

Referring to the drawing, although the operation method for an image display apparatus according to an embodiment of the present disclosure illustrated in FIG. 7B is similar to that of FIG. 6, there are differences in the step S524 and the step S525b. The following description will be given focusing on the differences.

After extracting color histogram of a plurality of regions of an input image signal in the step S520, the signal processing device 170 may be configured to perform the step S523 and the step S525b.

That is, the signal processing device 170 may be configured to update the color histogram based on the ratio of foreground and background regions among the plurality of regions (S524).

For example, the signal processing device 170 may be configured to update the color histogram of the plurality of regions in the previous frame image based on the ratio of foreground and background regions in the plurality of regions.

Next, the signal processing device 170 may be configured to update the image map or the depth map based on the updated color histogram of the plurality of regions (S525b).

For example, the signal processing device 170 may be configured to update the image map based on the depth map and the updated color histogram of the plurality of regions.

Next, the signal processing device 170 performs image quality processing based on the updated image map or the updated depth map (S530). Accordingly, it is possible to enhance the sense of presence in the foreground region while reducing artifacts.

According to FIG. 7B, the signal processing device 170 may be configured to extract an image map of an input image signal, update the color histogram of a plurality of regions of the input image signal, update the color histogram based on the image map and the ratio of foreground and background regions among the plurality of regions, update the image map based on the updated color histogram, and perform image quality processing based on the updated image map. Accordingly, it is possible to enhance the sense of presence in the foreground region while reducing artifacts.

The signal processing device 170 may be configured to extract an image map of an input image signal, perform color space-based conversion based on the image map, extract color histogram of a plurality of regions based on the color space-based conversion, update the image map based on the image map and the ratio of foreground and background regions among the plurality of regions, and perform image quality processing based on the updated image map. Accordingly, it is possible to enhance the sense of presence in the foreground region while reducing artifacts.

Meanwhile, as opposed to FIG. 7B, the signal processing device 170 may be configured to extract an image map of an input image signal, extract color histogram of a plurality of regions of the input image signal, update the color histogram based on the image map and region of interest among the plurality of regions update the image map based on the updated color histogram, and perform image quality processing based on the updated image map. Accordingly, it is possible to enhance the sense of presence in the region of interest while reducing artifacts.

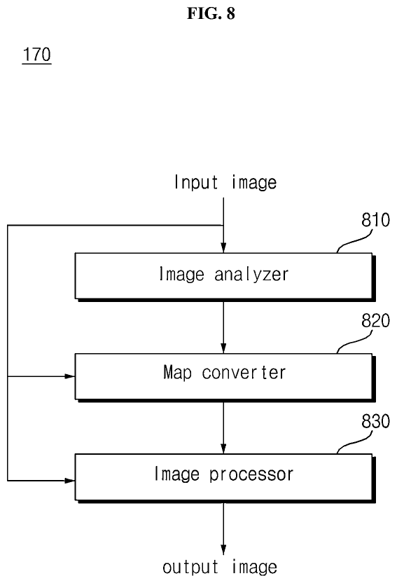

FIG. 8 is an internal block diagram of a signal processing device according to an embodiment of the present disclosure.

Referring to the drawing, the signal processing device 170 according to an embodiment of the present disclosure may include an image analyzer 810 configured to extract an image map of an input image signal and color histogram of a plurality of regions of the input image signal, a map converter 820 configured to update the image map based on the image map and the color histogram of the plurality of regions, and an image processor 830 configured to perform image quality processing based on the updated image map.

The image analyzer 810 may be configured to extract an image map or coordinate information based on the input image signal, or may be configured to extract an image map or coordinate information based on received metadata or a separate input image. Accordingly, it is possible to enhance the sense of presence while reducing artifacts.

For example, the image analyzer 810 may analyze the input image signal in real time and generate an analysis image or box-shaped coordinates that can be used in image conversion.

As another example, the image analyzer 810 may use previously generated metadata or an input image signal as an analysis image, without generating an analysis image on its own.

The image analyzer 810 may be configured to process the image map on a pixel-by-pixel basis.

For example, the image analyzer 810 may be configured to generate an analysis image on a pixel-by-pixel basis.

The image analyzer 810 may be configured to generate an analysis image for a number of neighboring pixels having similar properties.

The image analyzer 810 may be configured to generate an analysis image in various ways depending on the properties of the input image signal.

The map converter 820 may be configured to separate and process image information for a chromatic region and image information for an achromatic region.

For example, the map converter 820 may handle image information for a chromatic area and image information for an achromatic area separately, in a region that is deemed valid.

The map converter 820 may be configured to update the image map based on a cumulative histogram of image information of a valid region. Accordingly, it is possible to enhance the sense of presence in the valid region while reducing artifacts.

The map converter 820 may be configured to update the image map based on a cumulative histogram of image information of an invalid region and a cumulative histogram of image information of a valid region.

For example, the map converter 820 may be configured to construct a cumulative histogram of image information for a region that is deemed valid and reconstruct the image map, for example, an artificial intelligence (AI) map, on a pixel-by-pixel basis according to the distribution of image information of the plurality of regions.

The map converter 820 may be configured to update each region based on distribution of image information of the plurality of regions or may be configured to update the image map based on each updated region.

For example, the map converter 820 may be configured to construct a cumulative histogram of image information for a region that is deemed invalid and reconstruct the image map, for example, an artificial intelligence (AI) map, by comparing this image information with the image information acquired from the valid region.

Meanwhile, when constructing a cumulative histogram, the map converter 820 may be configured to select an image map, for example, an artificial intelligence map, corresponding to a desired region among the plurality of regions, and adjust the distribution of image information in each region.

The map converter 820 may be configured to generate an image map that is reconstructed according to the distribution of image information of the plurality of regions in a desired region among the plurality of regions, and combine a number of reconstructed image maps into a single image map in consideration of pixel distance.

The image processor 830 may be configured to adjust the sharpness or contrast of a foreground region or a region of interest among the plurality of regions.

For example, the image processor 830 may be configured to adjust the sharpness or contrast of the foreground on a pixel-by-pixel basis so as to make a foreground region or a region of interest among the plurality of regions stand out. Accordingly, it is possible to enhance the sense of presence in the foreground region or the region of interest while reducing artifacts.

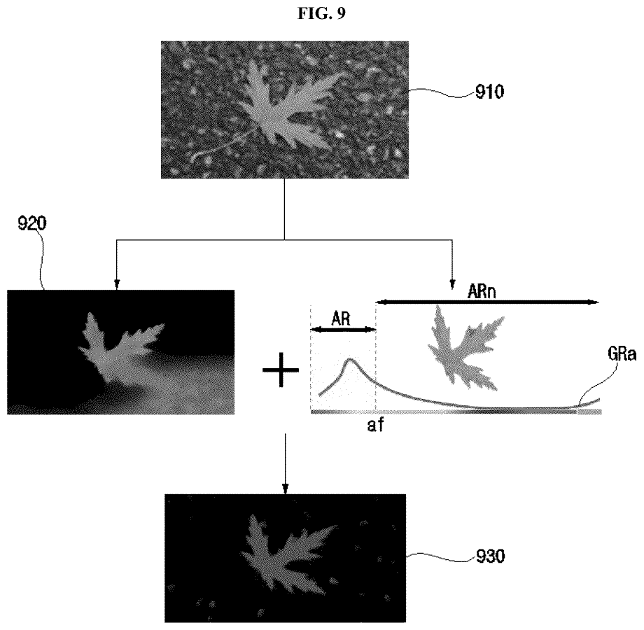

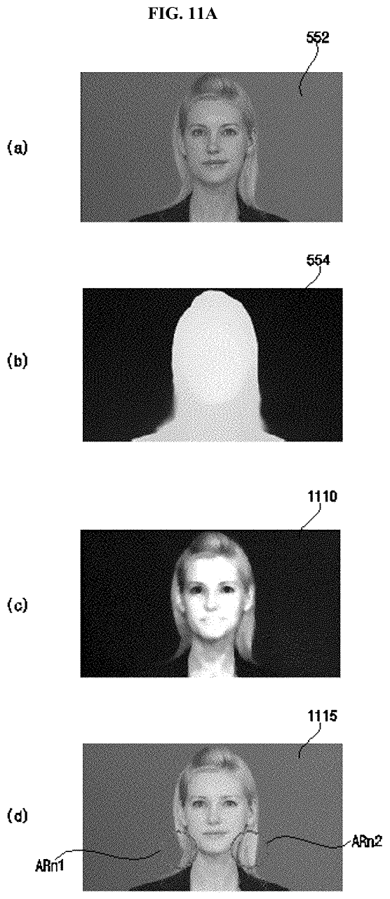

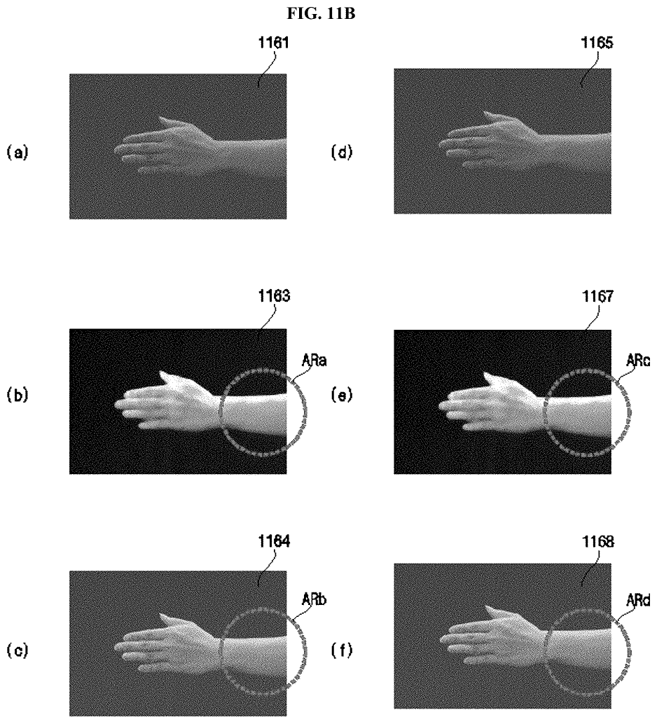

FIGS. 9 and 11B are diagrams referred to in the description of FIGS. 6 to 8.

FIG. 9 illustrates an example of processing an input image based on color histogram.

Referring to the drawing, the signal processing device 170 according to an embodiment of the present disclosure receives an input image 910 and extracts an image map 920 and color histogram of a plurality of regions of the input image signal based on the input image 910.

For example, the signal processing device 170 according to an embodiment of the present disclosure may be configured to extract HSV data in the input image 910, which is hue, saturation, and value data, and extract color histogram of a plurality of regions based on the extracted hue data, saturation data, and value data.

According to the color histogram in the drawing, the signal processing device 170 may take the region as a region of interest AR if the value of the transverse axis is equal to or higher than a reference value (af) and take the region as a region of no interest ARn if the value of the transverse axis exceeds the reference value (af).

As another example, the signal processing device 170 may take the region as a foreground region AR if the value of the transverse axis is equal to or less than a reference value (af) and take the region as a background region ARn if the value of the transverse axis exceeds the reference value (af).

The signal processing device 170 may calculate the ratio of the region of interest AR and the region of no interest ARn, update the color histogram based on the ratio of the region of interest AR and the region of no interest ARn, update the image map based on the updated color histogram, and perform image quality processing based on the updated image map.

As another example, the signal processing device 170 may calculate the ratio of the foreground region AR and the background region ARn, update the color histogram based on the ratio of the foreground region AR and the background region ARn, update the image map based on the updated color histogram, and perform image quality processing based on the updated image map.

That is, the signal processing device 170 may improve the sharpness or contrast of the foreground region AR or the region of interest AR among the plurality of regions.

Accordingly, the signal processing device 170 may be configured to display an image 930 with an enhanced sense of presence in the region of interest AR or the foreground region AR on the display 180.

Meanwhile, while updating the image map, the signal processing device 170 may be configured to increase the brightness of the foreground region AR or the region of interest AR among the plurality of regions as the level of hue or saturation in the foreground region AR or the region of interest AR increases. Accordingly, it is possible to enhance the sense of presence while reducing artifacts.

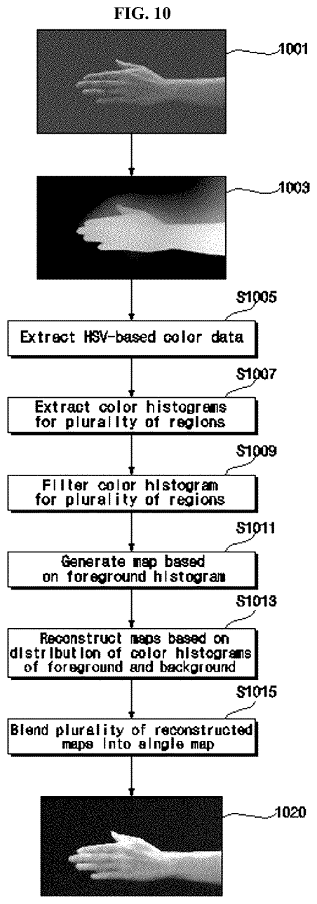

FIG. 10 illustrates an example of reconstructing or updating an image map in processing an input image based on color histogram.

Referring to the drawing, the signal processing device 170 may be configured to extract a depth map 1003 by performing depth processing on an input image 1001.

For example, the signal processing device 170 may be configured to extract a depth map 1003 by performing artificial intelligence-based depth processing on an input image 1001.

Next, the signal processing device 170 may be configured to extract HSV-based data based on the input image 1001 or the depth map 1003 (S1005).

For example, the signal processing device 170 may be configured to extract hue (H) data, saturation(S) data, and value (V) data, which is HSV-based data, based on the input image 1001 or the depth map 1003.

Next, the signal processing device 170 may be configured to extract color histogram of a plurality of regions, based on hue (H) data, saturation(S) data, and value (V) data, which is HSV-based data (S1007).

For example, the signal processing device 170 may be configured to extract color histogram of foreground and background regions, respectively, based on hue (H) data, saturation(S) data, and value (V) data, which is HSV-based data.

Next, the signal processing device 170 may be configured to filter the color histogram of the respective regions (S1009).

For example, the signal processing device 170 may be configured to perform low-pass filtering on the color histogram of the respective regions by using an IIR filter.

Next, the signal processing device 170 may be configured to generate an image map based on the filtered color histogram of the foreground region (S1011).

Next, the signal processing device 170 may be configured to update or reconstruct a plurality of image maps based on the ratio of the color histogram of the foreground and background region (S1013).

Next, the signal processing device 170 may be configured to blend the plurality of updated or reconstructed maps into a single map (S1015).

Accordingly, the signal processing device 170 is able to generate an updated image map 1020 in which the boundary regions around the hand and wrist are sharpened.

Also, the signal processing device 170 may be configured to perform image quality processing based on the updated image map 1020. Accordingly, it is possible to enhance the sense of presence while reducing artifacts.

FIG. 11A illustrates how signal processing of an input image works in an image display apparatus according to an embodiment of the present disclosure.

Referring to the drawing, the signal processing device 170 according to an embodiment of the present disclosure may be configured to extract a depth map of an input image 552 shown in (a) of FIG. 11A.

Meanwhile, a depth map 554 corresponding to the input image 552 may be as illustrated in (b) of FIG. 11A.

The signal processing device 170 according to an embodiment of the present disclosure may be configured to extract color histogram of a plurality of regions and update an image map based on the image map and the ratio of foreground region and background region among the plurality of regions.

For example, the signal processing device 170 according to an embodiment of the present disclosure may be configured to extract color histogram of a plurality of regions in the input image 552 and update a foreground region-based image map 1110 based on the depth map 554 and the ratio of foreground region and background region among the plurality of regions.

As another example, the signal processing device 170 according to an embodiment of the present disclosure may be configured to extract color histogram of a plurality of regions in the input image 552 and update a region-of-interest-based image map 1110 based on the depth map 554 and the ratio of region of interest and no interest among the plurality of regions.

Also, the signal processing device 170 according to an embodiment of the present disclosure may be configured to perform image quality processing based on the updated foreground region-based image map 1110 and display an image 1115 produced by image quality processing.

Accordingly, as opposed to FIG. 5A, the boundary regions ARn1 and ARn2 around the person's shoulder or hair in the image quality-processed image 1115 are displayed sharply without blurring. That is, it is possible to enhance the sense of presence while reducing artifacts in the boundary regions around the shoulder or the hair.

FIG. 11B illustrates how signal processing of first and second consecutive frame images works in an image display apparatus according to an embodiment of the present disclosure.

Referring to the drawing, the image display apparatus 100 according to an embodiment of the present disclosure is configured to extract an image map of a first frame image 1161 shown in (a) of FIG. 11B.

Next, the image display apparatus 100 may be configured to extract color histogram of a plurality of regions in the first frame image 1161, update the image map based on the ratio of foreground and background regions among the plurality of regions, and generate an updated image map 1163 based on the update the image map as shown in (b) of FIG. 11B.

In this case, since the updated image map 1163 is generated based on the color histogram of the plurality of regions, there is no blurring of the boundary region ARa around the wrist, as shown in (b) of FIG. 11B. That is, artifacts in the boundary region ARa around the wrist are reduced.

Next, the signal processing device 170 according to an embodiment of the present disclosure may be configured to perform image quality processing based on the updated image map 1163 shown in (b) of FIG. 11B, and display an image 1164 is displayed as shown in (c) of FIG. 11B.

As can be seen from the image 1164 in (c) of FIG. 11B, the sense of presence can be enhanced as artifacts in the boundary region ARb around the wrist are reduced.

Next, the image display apparatus 100 according to an embodiment of the present disclosure may be configured to extract an image map of a second frame image 1165 shown in (d) of FIG. 11B.

In this case, the second frame image 1165 is an image subsequent to the first frame image 1161, and there may be motion of the wrist which is at least part of an object in the image.

Next, the image display apparatus 100 may be configured to extract color histogram of a plurality of regions in the first frame image 1165, update the image map based on the ratio of foreground and background regions among the plurality of regions, and generate a second image map 1167, which is an updated image map, as shown in (e) of FIG. 11B, based on the updated the image map.

In this case, since the second image map 1167, which is an updated image map, is generated based on the color histogram of the plurality of regions, there is no blurring of the boundary region Arc around the wrist, as shown in (e) of FIG. 11B. That is, artifacts in the boundary region ARa around the wrist are reduced.

Next, the signal processing device 170 according to an embodiment of the present disclosure may be configured to perform image quality processing based on the second image map 1167, which is an updated image map, shown in (e) of FIG. 11B, and display a second image 1168 as shown in (f) of FIG. 11B.

As can be seen from the second image 1168 in (f) of FIG. 11B, the sense of presence can be enhanced as artifacts in the boundary region ARd around the wrist are reduced.

As discussed above, in response to motion of the wrist, which is an object in the first frame image 1161 and the second frame image 1165 which are consecutive frames, the signal processing device 170 may be configured to update the color histogram based on the image map of the second frame image and the color histogram, update the second image map 1167 of the second frame image 1165 based on the updated color histogram, and perform image quality processing based on the updated second image map 1167 of the second frame image 1165. Accordingly, it is possible to enhance the sense of presence while reducing artifacts.

As described above, an image display apparatus according to an embodiment of the present disclosure may include a display; and a signal processing device configured to process an input image signal and output an output image signal, wherein the signal processing device is configured to extract an image map of the input image signal and color histogram of a plurality of regions of the input image signal, update the image map based on the color histogram of the plurality of regions, and perform image quality processing based on the updated image map. Accordingly, it is possible to enhance the sense of presence while reducing artifacts.

The signal processing device may be configured to extract an image map of a first frame image of the input image signal, update the color histogram based on the image map of the first frame image and the color histogram of a frame image previous to the first frame image, update the image map of the first frame image based on the updated color histogram, and perform image quality processing based on the updated image map of the first frame image. Accordingly, it is possible to enhance the sense of presence while reducing artifacts.

The signal processing device may be configured to extract an image map of the input image signal, extract color histogram of a plurality of regions of the input image signal, update the color histogram based on the image map and the ratio of foreground and background regions among the plurality of regions, update the image map based on the updated color histogram, and perform image quality processing based on the updated image map. Accordingly, it is possible to enhance the sense of presence in the foreground region while reducing artifacts.

The signal processing device may be configured to extract an image map of the input image signal, extract color histogram of a plurality of regions of the input image signal, update the color histogram based on the image map and region of interest among the plurality of regions, update the image map based on the updated color histogram, and perform image quality processing based on the updated image map. Accordingly, it is possible to enhance the sense of presence in the region of interest while reducing artifacts.

The signal processing device may be configured to extract an image map of the input image signal, perform color space-based conversion based on the image map, extract color histogram of a plurality of regions based on the color space-based conversion, update the image map based on the image map and the ratio of foreground and background regions among the plurality of regions, and perform image quality processing based on the updated image map. Accordingly, it is possible to enhance the sense of presence in the foreground region while reducing artifacts.

While updating the image map, the signal processing device may be configured to increase the brightness of a first region among the plurality of regions in the updated image map as the level of color hue or saturation in the first region increases. Accordingly, it is possible to enhance the sense of presence while reducing artifacts.

In response to motion of an object in consecutive first and second frame images, the signal processing device may be configured to extract an image map of the second frame image, update the color histogram image based on the image map of the second frame image and the color histogram, update the image map of the second frame image based on the updated color histogram, and perform image quality processing based on the updated image map of the second frame image. Accordingly, it is possible to enhance the sense of presence while reducing artifacts in response to motion of an object in the image.

The image map may include an artificial intelligence-based image map or a depth map. Accordingly, it is possible to enhance the sense of presence while reducing artifacts.

The signal processing device may include: an image analyzer configured to extract an image map of an input image signal and color histogram of a plurality of regions of the input image signal; a map converter configured to update the image map based on the image map and the color histogram of the plurality of regions; and an image processor configured to perform image quality processing based on the updated image map. Accordingly, it is possible to enhance the sense of presence while reducing artifacts.

The image analyzer may be configured to extract an image map or coordinate information based on the input image signal, or may be configured to extract an image map or coordinate information based on received metadata or a separate input image. Accordingly, it is possible to enhance the sense of presence while reducing artifacts.

The image analyzer may be configured to process an image map on a pixel-by-pixel basis. Accordingly, it is possible to enhance the sense of presence while reducing artifacts.

The map converter may be configured to separate and process image information for a chromatic region and image information for an achromatic region. Accordingly, it is possible to enhance the sense of presence while reducing artifacts.

The map converter may be configured to update the image map based on a cumulative histogram of image information of a valid region. Accordingly, it is possible to enhance the sense of presence in the valid region while reducing artifacts.

The map converter may be configured to update the image map based on a cumulative histogram of image information of an invalid region and a cumulative histogram of image information of a valid region. Accordingly, it is possible to enhance the sense of presence in the valid region while reducing artifacts.

The map converter may be configured to update each region based on distribution of image information of the plurality of regions or update the image map based on each updated region. Accordingly, it is possible to enhance the sense of presence while reducing artifacts.

The image processor may be configured to adjust the sharpness or contrast of a foreground region or a region of interest among the plurality of regions. Accordingly, it is possible to enhance the sense of presence in the foreground region or the region of interest while reducing artifacts.

An image display apparatus according to another embodiment of the present disclosure may include a display; and a signal processing device configured to process an input image signal and output an output image signal, wherein, in response to motion of an object in consecutive first and second frame images, the signal processing device may be configured to extract an image map of the second frame image, update the color histogram image based on the image map of the second frame image and the color histogram, update the image map of the second frame image based on the updated color histogram, and perform image quality processing based on the updated image map of the second frame image. Accordingly, it is possible to enhance the sense of presence while reducing artifacts in response to motion of an object in the image.

While the disclosure has been described with reference to the embodiments, the disclosure is not limited to the above-described specific embodiments, and it will be understood by those skilled in the related art that various modifications and variations may be made without departing from the scope of the disclosure as defined by the appended claims, as well as these modifications and variations should not be understood separately from the technical spirit and prospect of the disclosure.

What is claimed is:

1. An image display apparatus comprising:
a display; and
a signal processing device configured to process an input image signal and output an output image signal, the signal processing device being configured to:
extract an image map and a color histogram of the input image signal,
update the image map based on the color histogram, and
perform image quality processing based on the updated image map.

2. The image display apparatus of claim 1, wherein the signal processing device is configured to:
extract the image map of a first frame image of the input image signal,
update the color histogram of a plurality of regions based on the image map of the first frame image and the color histogram of the plurality of regions of a frame image previous to the first frame image,
update the image map of the first frame image based on the updated color histogram of the plurality of regions, and
perform the image quality processing based on the updated image map of the first frame image.

3. The image display apparatus of claim 1, wherein the signal processing device is configured to:
extract the color histogram of a plurality of regions of the input image signal,
update the color histogram of the plurality of regions based on the image map and a ratio of foreground and background regions among the plurality of regions,
update the image map based on the updated color histogram of the plurality of regions, and
perform the image quality processing based on the updated image map.

4. The image display apparatus of claim 1, wherein the signal processing device is configured to:
extract the color histogram of a plurality of regions of the input image signal,
update the color histogram of the plurality of regions based on the image map and a region of interest among the plurality of regions,
update the image map based on the updated color histogram, and
perform the image quality processing based on the updated image map.

5. The image display apparatus of claim 1, wherein the signal processing device is configured to:
perform color space-based conversion based on the image map,
extract the color histogram of a plurality of regions based on the color space-based conversion,
update the image map based on the image map and a ratio of foreground and background regions among the plurality of regions, and
perform the image quality processing based on the updated image map.

6. The image display apparatus of claim 1, wherein, while updating the image map, the signal processing device is configured to increase a brightness of a first region among a plurality of regions in the updated image map as a level of color hue or saturation in the first region increases.

7. The image display apparatus of claim 1, wherein, in response to motion of an object in consecutive first and second frame images, the signal processing device is configured to:
extract an image map of the second frame image,
update the color histogram based on the image map of the second frame image,
update the image map of the second frame image based on the updated color histogram, and
perform the image quality processing based on the updated image map of the second frame image.

8. The image display apparatus of claim 1, wherein the signal processing device includes:
an image analyzer configured to extract the image map of the input image signal and the color histogram of a plurality of regions of the input image signal;
a map converter configured to update the image map based on the color histogram of the plurality of regions; and
an image processor configured to perform the image quality processing based on the updated image map.

9. The image display apparatus of claim 8, wherein the image analyzer is configured to extract coordinate information based on the input image signal, or extract the image map or coordinate information based on received metadata or a separate input image.

10. The image display apparatus of claim 8, wherein the map converter is configured to separate and process image information for a chromatic region and image information for an achromatic region.

11. The image display apparatus of claim 8, wherein the map converter is configured to update the image map based on a cumulative histogram of image information of a valid region.

12. The image display apparatus of claim 8, wherein the map converter is configured to update the image map based on a cumulative histogram of image information of an invalid region and a cumulative histogram of image information of a valid region.

13. The image display apparatus of claim 8, wherein the map converter is configured to update each region of the plurality of regions based on distribution of image information of the plurality of regions or update the image map based on each updated region.

14. The image display apparatus of claim 9, wherein the image processor is configured to adjust a sharpness or a contrast of a foreground region or a region of interest among the plurality of regions.

15. An image display apparatus comprising:
a display; and
a signal processing device configured to process an input image signal and output an output image signal,
wherein, in response to motion of an object in first and second frame images, the signal processing device is configured to:
extract an image map of the second frame image,
update a color histogram image based on the image map of the second frame image,
update the image map of the second frame image based on the updated color histogram, and
perform image quality processing based on the updated image map of the second frame image.

16. The image display apparatus of claim 15, wherein the signal processing device includes:
an image analyzer configured to extract the image map of the input image signal and the color histogram of a plurality of regions of the input image signal;
a map converter configured to update the image map based on the color histogram of the plurality of regions; and
an image processor configured to perform the image quality processing based on the updated image map.

17. The image display apparatus of claim 16, wherein the image analyzer is configured to extract coordinate information based on the input image signal, or extract the image map or coordinate information based on received metadata or a separate input image.

18. The image display apparatus of claim 16, wherein the map converter is configured to update the image map based on a cumulative histogram of image information of a valid region, or update the image map based on a cumulative histogram of image information of an invalid region and the cumulative histogram of the image information of the valid region.

19. The image display apparatus of claim 16, wherein the map converter is configured to update each region of the plurality of regions based on distribution of image information of the plurality of regions or update the image map based on each updated region.

20. The image display apparatus of claim 16, wherein the image processor is configured to adjust a sharpness or a contrast of a foreground region or a region of interest among the plurality of regions.

21. A signal processing device comprising:
an image analyzer configured to extract an image map of an image and a color histogram of the image of an input image signal;
a map converter configured to update the image map based on the color histogram; and
an image processor configured to perform image quality processing of the image based on the updated image map,
wherein the signal processing device is configured to receive an input image signal and output an output image signal, and
wherein the output image signal is based on the quality processed image.

22. The signal processing device of claim 21, wherein the signal processing device is configured to output the output image signal to a display.

23. The signal processing device of claim 21, further comprising a demultiplexer configured to process an input stream and separate the input stream into image data and audio data.
